(19) United States
(12) Patent Application Publication
(10) Pub. No.: US 2026/0005276 A1
(43) Pub. Date: Jan. 1, 2026

(54) Fuel Cell System and Method of Controlling the Same

(71) Applicants: HYUNDAI MOTOR COMPANY, Seoul (KR); KIA CORPORATION, Seoul (KR)

(72) Inventors: Jae Ho Han, Hwaseong-si (KR); Dae Jong Kim, Hwaseong-si (KR); Jae Ok Ha, Hwaseong-si (KR)

(73) Assignees: HYUNDAI MOTOR COMPANY, Seoul (KR); KIA CORPORATION, Seoul (KR)

(21) Appl. No.: 18/955,587

(22) Filed: Nov. 21, 2024

(30) Foreign Application Priority Data
Jul. 1, 2024 (KR) 10-2024-0086248

(51) Int. Cl. H01M 8/04858; H01M 8/04537

(52) U.S. Cl. CPC H01M 8/0488; H01M 8/04559

(57) ABSTRACT

Disclosed are a fuel cell system and control method thereof, the fuel cell system comprising a fuel cell stack including a plurality of cells, and a controller that controls an output of the stack based on an available lower limit voltage of the stack, and adjust the available lower limit voltage of the stack by reflecting at least one of a first margin according to a cell voltage ratio and a second margin according to an available output of a provided battery when the cell voltage ratio, which is a ratio of a minimum cell voltage and an average cell voltage for the stack, is less than a preset reference cell voltage ratio.

### CROSS-REFERENCE TO RELATED APPLICATION

The present application claims priority to Korean Patent Application No. 10-2024-0086248, filed Jul. 1, 2024, the entire contents of which is incorporated herein for all purposes by this reference.

### TECHNICAL FIELD

The present disclosure relates to a fuel cell system and a control method thereof that adjust the available lower limit voltage of a fuel cell stack to delay performance degradation of the fuel cell stack.

### BACKGROUND

Fuel cell vehicles generally include a stack that generates electricity by generating electrical energy through an electrochemical reaction between fuel and oxidizer, a fuel supply device that supplies fuel gas to the anode of the stack through a fuel gas supply channel, an air supply device that supplies air containing oxygen to the cathode of the stack through an oxidizing gas supply channel, a thermal management device that controls the operating temperature of the stack, and a control device that controls the operation of the fuel cell system.

In such a fuel cell system, hydrogen, which is the fuel, is oxidized at the anode (oxidation electrode) of the stack to generate hydrogen ions and electrons. Anode hydrogen ions pass through an electrolyte membrane and move to the cathode (reduction electrode), where oxygen is reduced and water is generated. Here, electrons move from the anode to the cathode through an external conductor, generating electrical energy.

Meanwhile, during operation of the fuel cell stack, it can be diagnosed whether the performance of the fuel cell stack is degraded, and the diagnosis of whether the performance of the fuel cell stack is degraded is generally performed based on the cell voltage ratio of the fuel cell stack. Here, the cell voltage ratio refers to a ratio of a minimum voltage to an average voltage according to the voltage of each cell included in the fuel cell stack. If deterioration in the performance of the fuel cell stack is diagnosed according to the cell voltage ratio, control to induce replacement of the fuel cell stack is performed.

The information disclosed in the Background is only for enhancement of understanding of the general background of the disclosure and should not be taken as an acknowledgement that this information forms the prior art already known to a person skilled in the art.

### SUMMARY

An object of the present disclosure is to provide a fuel cell system and a control method thereof that can delay performance degradation of the fuel cell stack by detecting signs of performance degradation of the fuel cell stack in advance and adjusting the available lower limit voltage of the fuel cell stack.

The object of the disclosure is not limited to the above-mentioned object, and other objects not mentioned may be clearly understood by those skilled in the art from the following descriptions.

In order to implement the above object, a fuel cell system according to an embodiment of the present disclosure comprises a fuel cell stack including a plurality of cells, and a controller that controls an output of the stack based on an available lower limit voltage of the stack, and adjust the available lower limit voltage of the stack by reflecting at least one of a first margin according to a cell voltage ratio which is a ratio of a minimum cell voltage and an average cell voltage of the stack and a second margin according to an available output of a battery provided in the system when the cell voltage ratio is less than a preset reference cell voltage ratio.

In order to implement the above object, a control method of a fuel cell system according to an embodiment of the present disclosure comprises comparing, by a controller, a cell voltage ratio, which is a ratio of a minimum cell voltage and an average cell voltage of a fuel cell stack including a plurality of cells, with a preset reference cell voltage ratio, adjusting, by the controller, an available lower limit voltage of the stack by reflecting at least one of a first margin according to the cell voltage ratio and a second margin according to an available output of a battery provided in the system when the cell voltage ratio is less than the preset reference cell voltage ratio, and controlling, by the controller, an output of the stack based on the available lower limit voltage.

According to various embodiments of the present disclosure as described above, it is possible to detect performance degradation of individual cells in advance during the operation of the fuel cell stack, and delay performance degradation before the performance of the fuel cell stack deteriorates to a replacement requirement level.

In addition, by variably controlling the available lower limit voltage of the fuel cell stack during operation of the fuel cell stack, it is possible to delay performance degradation of the fuel cell stack and alleviate the sense of heterogeneity due to output fluctuations.

The effects that can be obtained from the disclosure are not limited to the above mentioned effects, and other effects not mentioned will be clearly understood by those skilled in the art from the description below.

### BRIEF DESCRIPTION OF THE DRAWINGS

FIG. 1 is a diagram illustrating the configuration of a fuel cell system according to an embodiment of the present disclosure.

FIG. 2 is a diagram for explaining a first margin when adjusting an available lower limit voltage according to an embodiment of the present disclosure.

FIG. 3 is a diagram for explaining a second margin when adjusting an available lower limit voltage according to an embodiment of the present disclosure.

FIG. 4 is a diagram for explaining a reflection ratio of a first margin and second margin according to an embodiment of the present disclosure.

FIG. 5 is a diagram for explaining margin relaxation when adjusting an available lower limit voltage according to an embodiment of the present disclosure.

FIG. 6 is a diagram for explaining a reference cell voltage ratio according to an embodiment of the present disclosure.

FIG. 7 is a flowchart for explaining a control method of a fuel cell system according to an embodiment of the present disclosure.

### DETAILED DESCRIPTION

Specific structural or functional descriptions of the embodiments of the present disclosure disclosed in the present specification or application are presented by way of examples for the purpose of describing the embodiments according to the present disclosure, and the embodiments according to the present disclosure may be implemented in various forms and should not be construed as being limited to the embodiments described in the present specification or application.

The embodiments according to the present disclosure may be variously modified and may have various shapes, so examples of which are illustrated in the accompanying drawings and will be described in detail with reference to the accompanying drawings. However, it should be understood that the embodiments according to the concept of the present disclosure are not limited to the embodiments, but various modifications, equivalents, additions and substitutions are possible, without departing from the scope and spirit of the disclosure.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, an embodiment disclosed in the present specification will be described in detail with reference to the accompanying drawings. Regardless of the reference numerals, identical or similar components will be given the same reference numbers and duplicate descriptions thereof will be omitted.

In the descriptions of the following embodiments, the term “preset” indicates that the numerical value of a parameter is previously decided when the parameter is used in a process or algorithm. According to an embodiment, the numerical value of the parameter may be set when the process or algorithm is started or while the process or algorithm is performed.

Suffixes ‘module’ and ‘unit’ for a component used in the present specification are given or used interchangeably in consideration of facilitation in preparing the specification only but do not have meanings or roles different from each other.

In describing the embodiments disclosed in the present specification, if the detailed description of the related art is determined as making the subject matter of the embodiments disclosed in the present specification unclear, it will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

Terminologies, each of which includes such an ordinal number as 1^{st}, 2^{nd}, and the like, may be used to describe various components. In doing so, the various components should be non-limited by the corresponding terminologies, respectively. The terminologies are only used for the purpose of discriminating one component from other components.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the possibility of the presence or addition of one or more other features, integers, steps, operations, elements, components, and/or combinations.

Further, the term “unit” included in, for example, fuel cell control unit (FCU) or control unit may be widely used to refer to a controller configured to control a specific function of the system, but may not mean a generic functional unit.

The controller may include a communication device that communicates with other controllers or sensors to control assigned functions, a memory that stores an operating system or logic commands and input/output information, and one or more processors that perform the judgments, calculations, and decisions required to control assigned functions.

A fuel cell system and control method thereof according to an embodiment of the present disclosure propose detecting performance degradation of a fuel cell stack (e.g., early) based on a reference cell voltage ratio that changes depending on the state-of-health (SOH) of the fuel cell stack during operation of the fuel cell stack, and adjusting an available lower limit voltage of the fuel cell stack according to a state of the fuel cell system, thereby delaying performance degradation of the fuel cell stack, protecting the fuel cell stack, and improving the performance of the fuel cell system.

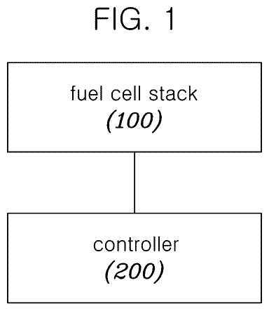

Hereinafter, before explaining a control method of a fuel cell system according to an embodiment of the present disclosure, a fuel cell system according to an embodiment of the present disclosure will first be described with reference to FIGS. 1 to 6, and for convenience of explanation, a ‘fuel cell stack’ may be expressed as a ‘stack’.

FIG. 1 is a diagram illustrating the configuration of a fuel cell system according to an embodiment of the present disclosure.

Referring to FIG. 1, a fuel cell system according to an embodiment of the present disclosure includes a fuel cell stack 100 and a controller 200 and can be implemented as a fuel cell vehicle. However, FIG. 1 mainly illustrates components related to the description of an embodiment of the present disclosure, and it is apparent that an actual fuel cell vehicle may be implemented including more or fewer components than the illustrated components.

The fuel cell stack 100 may include a plurality of cells, and the performance of the stack 100 may be affected by the individual performance of each of the plurality of cells constituting the stack 100.

The controller 200 controls the output of the stack 100 based on the available lower limit voltage of the stack 100, where the available lower limit voltage is an indicator of the performance of the stack 100 and may serve as a reference for determining whether the stack 100 needs to be replaced.

In addition, the controller 200 evaluates the performance of the stack 100 by comparing a cell voltage ratio, which is a ratio of a minimum cell voltage and average cell voltage for the stack 100, with a preset reference cell voltage ratio, and thus, may adjust an available lower limit voltage of the stack 100 according to the results of the performance evaluation. Here, the reference cell voltage ratio is a design specification of a fuel cell vehicle or fuel cell system applied thereto, and is set in consideration of the durability and performance of the fuel cell stack 100, and may be set at a level of 0.6 to 1, for example, and may vary, such as being raised or lowered, depending on the operation strategy of the fuel cell stack 100.

In particular, when adjusting the available lower limit voltage of the stack 100, the controller 200 may reflect the state of the stack 100 and the vehicle state, including the output capability of the vehicle.

More specifically, the controller 200 reflects at least one of a first margin according to the cell voltage ratio indicating the state of the stack 100, and a second margin according to the available output of the battery indicating the output capability of the vehicle to adjust the available lower limit voltage of the stack 100.

Here, adjustment of the available lower limit voltage may be performed by adding at least one of the first margin and the second margin to the available lower limit voltage before adjustment, and accordingly, the available lower limit voltage after adjustment is higher than the available lower limit voltage before adjustment. Additionally, the available lower limit voltage before adjustment may be a value set to correspond to the initial state (BOL: Begin of Life) of the stack 100. That is, the adjustment of the available lower limit voltage may be performed in a direction that increases the available lower limit voltage as the performance of the stack 100 deteriorates.

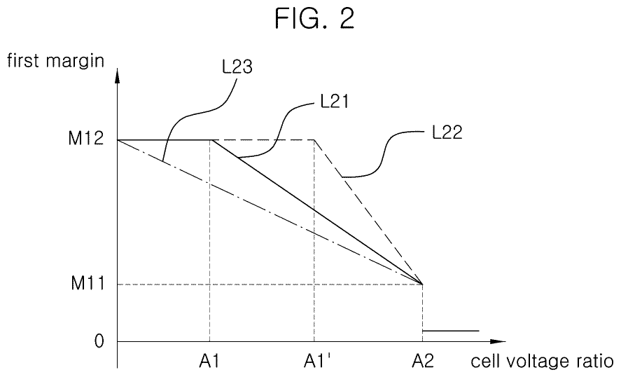

The first margin for adjusting the available lower limit voltage will be described in detail with reference to FIG. 2 below.

FIG. 2 is a diagram for explaining the first margin when adjusting the available lower limit voltage according to an embodiment of the present disclosure.

FIG. 2 shows a graph with the first margin as the vertical axis and the cell voltage ratio of the stack 100 as the horizontal axis.

The first margin has a different value for each of the plurality of cell voltage ratio sections for the stack 100, and may have a higher value in a section where the cell voltage ratio is low compared to a section where the cell voltage ratio is high.

The cell voltage ratio indicates the state of performance degradation of the stack 100. The lower the cell voltage ratio, the lower the performance of the stack 100. Therefore, in a section where the cell voltage ratio is low, where the need to delay performance degradation of the stack 100 is (e.g., relatively) high, the first margin is made to have a larger value, so that the available lower limit voltage is increased.

In this case, the first margin has a minimum value M11 at the point where the cell voltage ratio is the reference cell voltage ratio A2, and may converge to the maximum value M12 as the cell voltage ratio approaches ‘0’ (L21).

The reference cell voltage ratio A2 is a reference for determining the need for adjustment of the available lower limit voltage. Since the available lower limit voltage is adjusted when the cell voltage ratio is less than the reference cell voltage ratio A2, the first margin has a minimum value in a section where the cell voltage ratio is larger than the voltage ratio A2.

In addition, if the available lower limit voltage is increased indefinitely as the cell voltage ratio decreases, the drivability of the vehicle may deteriorate. Therefore, when the cell voltage ratio decreases below a certain value, the first margin no longer increases and is fixed to the maximum value M12.

Additionally, the starting point where the first margin converges to the maximum value may be determined based on at least one of a pre-stored driving history and a preset driving mode.

Here, the driving history may indicate the driving tendency, such as the frequency of driving performed in the high-current/low-current region, and the driving mode may include a sport mode, which prioritizes output performance, or an eco mode, which prioritizes output efficiency.

Additionally, the starting point where the first margin converges to the maximum value may be determined by considering the priorities between protection of the stack 100 and drivability. For example, with the point where the cell voltage ratio of A1 is set as the starting point where the first margin converges to a default maximum value, if the main driving region according to the driving history is a high current region or the driving mode is a sport mode, the point where the cell voltage ratio is A1′ may be the starting point where the first margin converges to the maximum value (L22). If the main driving region according to the driving history is a low current region or the driving mode is an eco mode, the first margin may not converge to the maximum value until the cell voltage ratio becomes 0 (L23). However, this is an example of a case where the protection of the stack 100 is a (e.g., higher) priority, and the opposite case may also be assumed when drivability is a (e.g., higher) priority.

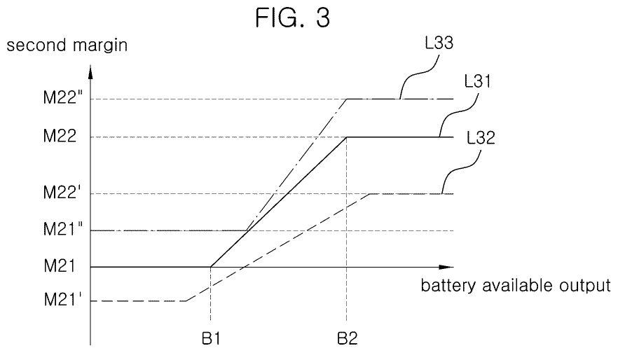

The second margin for adjusting the available lower limit voltage will be described in detail with reference to FIG. 3 below.

FIG. 3 is a diagram for explaining the second margin when adjusting the available lower limit voltage according to an embodiment of the present disclosure.

FIG. 3 shows a graph with the second margin as the vertical axis and the available output of the battery as the horizontal axis.

The second margin has a different value for each section of the available output of the battery and may have a lower value in a section where the available output of the battery is low compared to a section where the available output of the battery is high.

In a section where the available output of the battery is relatively low, there is a (e.g., high) need to secure the output of the stack 100 even if the performance of the stack 100 deteriorates rather quickly in order to secure basic driving performance. Thus, in a section where the available output of the battery is relatively low, the second margin is made to have a smaller value so that the available lower limit voltage increases less.

In this case, the second margin has a maximum value M22 in the section where the available output of the battery exceeds a preset reference available output B2, and may converge to a minimum value M21 as the available output of the battery approaches ‘0’ (L31).

Here, the reference available output B2 may be set based on the maximum output of the drive motor provided in the vehicle, and for example, may be set to a point that is 80% of the maximum output of the drive motor.

Meanwhile, the maximum and minimum values of the second margin may be determined based on at least one of a pre-stored driving history and a preset driving mode. Here, the minimum value M21 of the second margin may be set to ‘0’, but is not necessarily limited thereto, and may be determined to be a value greater than ‘0’ or smaller than ‘0’ depending on the driving history and driving mode. The maximum and minimum values of the second margin may also have an increased value M22′ or a decreased value M22′ from the default maximum value M22 depending on the driving history and driving mode. For example, if the main driving region according to the driving history is a high current region or the driving mode is a sport mode, the maximum value of the second margin may be determined as M22′, which is less than the default value M22, and the minimum value may be determined as M21′, which is less than the default value M21 (L32). If the main driving region according to the driving history is a low current region or the driving mode is an eco mode, the maximum value of the second margin is M22″, which is greater than the default value M22, and the minimum value may be determined as M21″, which is greater than the default value ‘M21’ (L33). However, this is an example of a case where the protection of the stack 100 is a (e.g., higher) priority, and the opposite case may also be assumed when drivability is a (e.g., higher) priority.

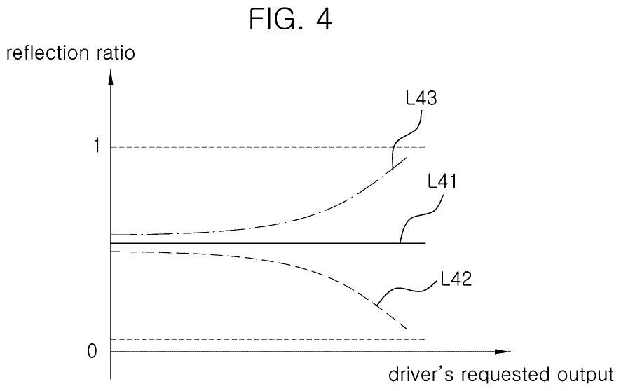

Meanwhile, the controller 200 may adjust the available lower limit voltage of the stack 100 by considering both the first margin and the second margin. This will be described below with reference to FIG. 4.

FIG. 4 is a diagram for explaining the reflection ratio of the first margin and second margin according to an embodiment of the present disclosure.

FIG. 4 shows a graph with the reflection ratio of the first margin and second margin on the vertical axis and the driver's requested output on the horizontal axis.

When adjusting the available lower limit voltage of the stack 100 by considering the first margin and second margin together, the controller 200 may reflect the first margin and second margin at a preset reflection ratio.

When the available lower limit voltage of the stack 100 is adjusted by considering the first margin and second margin together, it is possible to simultaneously delay performance degradation of the stack 100 and secure drivability by alleviating the sense of heterogeneity of the output.

In this case, the reflection ratio of the first margin and second margin may be set to correspond to at least one of the pre-stored driving history and the preset driving mode and the driver's requested output.

For example, the reflection ratio is set to have a constant value regardless of the change in the driver's requested output (L41), as shown in FIG. 4, or is set to increase or decrease when the driver's requested output changes depending on the driving history and driving mode. For example, if the main driving region according to the driving history is a high current region or the driving mode is a sport mode, the reflection ratio may be set to decrease when the driver's requested output increases (L42). If the main driving region according to the driving history is a low current region or the driving mode is an eco mode, the reflection ratio may be set to increase when the driver's requested output increases (L43). However, this is an example of a case where the protection of the stack 100 is a (e.g., higher) priority, and the opposite case may also be assumed when drivability is a (e.g., higher) priority.

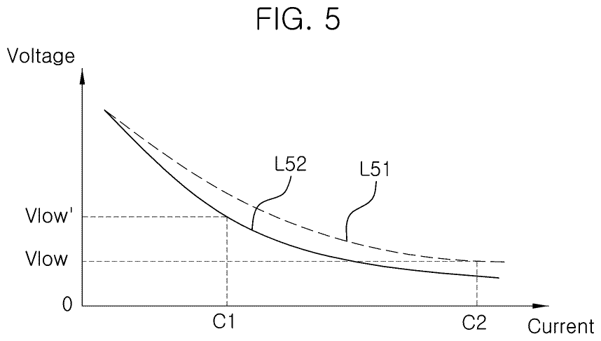

Meanwhile, the controller 200 may adjust the available lower limit voltage again after adjusting the available lower limit voltage of the stack 100. In this case, the controller 200 may not only increase the available lower limit voltage, but also lower the available lower limit voltage. This will be described below with reference to FIG. 5.

FIG. 5 is a diagram for explaining margin relaxation when adjusting the available lower limit voltage according to an embodiment of the present disclosure.

Referring to FIG. 5, the vertical and horizontal axes represent the voltage and current of the stack 100, respectively. FIG. 5 shows an I-V (e.g., current-voltage) curve L51 for the initial available lower limit voltage Vlow set to correspond to the initial state (BOL) of the stack 100, and an I-V curve L52 for the current available lower limit voltage Vlow′ increased from the initial available lower limit voltage Vlow.

The controller 200 may adjust the available lower limit voltage by further considering a margin relaxation ratio that varies depending on a change in current corresponding to the available lower limit voltage.

The margin relaxation ratio may vary according to a change in the current corresponding to the available lower limit voltage, and in particular may be reduced as the current corresponding to the available lower limit voltage increases.

For example, the margin relaxation ratio has a value between ‘0’ and ‘l’ and is applied to the first margin and second margin, so that the margin relaxation ratio serves to reduce the increase in the available lower limit voltage of the stack 100 as the value becomes smaller.

An increase in the current corresponding to the available lower limit voltage may indicate recovery of the performance of the stack 100, and the margin relaxation ratio is reduced as the current corresponding to the above available lower limit voltage increases. Accordingly, recovery of the state of the stack 100 may be reflected in adjusting the available lower limit voltage.

More specifically, in a state where the initial available lower limit voltage Vlow set to correspond to the initial state (BOL) of the stack 100 is increased to the currently available lower limit voltage Vlow′, the margin relaxation ratio may have a smaller value as a current C1 corresponding to the current available lower limit voltage Vlow′ increases toward a current C2 corresponding to the initial available lower limit voltage Vlow.

In this case, the margin relaxation ratio may change depending on an amount that the current C1 corresponding to the current available lower limit voltage Vlow′ increases. In contrast, the margin relaxation ratio may change depending on the number of times the current C1 corresponding to the current available lower limit voltage Vlow′ increases.

For example, the margin relaxation ratio has a value of ‘l’ in the initial state and decreases each time the current C1 corresponding to the current available lower limit voltage Vlow′ increases. Thus, when the current C1 corresponding to the current available lower limit voltage Vlow′ is increased 10 times, the margin relaxation ratio may have a value of ‘0’. In a state where the margin relaxation ratio has a value of ‘1’, 100% of the margin is reflected when adjusting the available lower limit voltage, resulting in a higher available lower limit voltage. In addition, when the margin relaxation ratio has a value of ‘O’, the margin is excluded when adjusting the available lower limit voltage, so that the available lower limit voltage becomes less high.

Summarizing the above-mentioned information, the available cell voltage may be adjusted according to Equation 1 below.

Available cell voltage (adjusted)=available cell voltage (initial state)+margin×margin relaxation ratio (Equation 1)

Here, a safety margin may be expressed again as Equation 2 below.

Margin=default margin set value+(first margin×reflection ratio+second margin×(1−reflection ratio)) (Equation 2)

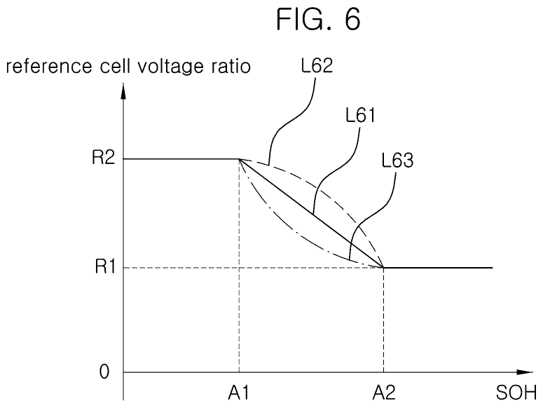

Meanwhile, adjustment of the available lower limit voltage may be performed when the cell voltage ratio of the stack 100 is less than a reference cell voltage ratio. This will be described below with reference to FIG. 6.

FIG. 6 is a diagram for explaining a reference cell voltage ratio according to an embodiment of the present disclosure.

FIG. 6 shows a graph with the reference cell voltage ratio as the vertical axis and the SOH of the stack 100 as the horizontal axis.

As shown, the reference cell voltage ratio may be set to vary depending on the SOH of the stack. In this case, the reference cell voltage ratio has different values for each of the plurality of SOH sections for the stack 100, but it may have higher value in a section where the SOH is high compared to a section where the SOH is low.

The reference cell voltage ratio may be a reference for determining whether there is a need to delay performance degradation even if the output of the stack 100 is somewhat limited, and as the reference cell voltage ratio is set to vary depending on the SOH, it is possible to provide a judgment reference suitable for the current state of the stack 100. In particular, as the SOH decreases, the risk of performance degradation of the stack 100 increases, so the reference cell voltage ratio has a higher value in the section where the SOH is low, so that adjustment of the available lower limit voltage can be performed at a faster time.

More specifically, the reference cell voltage ratio may have a minimum value R1 when the SOH of the stack 100 exceeds a preset value A2 to correspond to the initial state BOL of the stack 100. Also, the reference cell voltage ratio may have a maximum value R2 when the SOH is less than a preset value A1 to correspond to the end-of-life (EOL) state of the stack 100 (L61).

In addition, the reference cell voltage ratio may vary between the minimum value R1 and the maximum value R2 in a section between the preset value A2 to correspond to the initial state (BOL) of the stack 100 and the preset value A1 to correspond to the end-of-life state (EOL) of the stack 100.

In this case, the rate of change of the variable reference cell voltage ratio may be determined based on at least one of a pre-stored driving history and a preset driving mode, and the priority between protection of the stack 100 and drivability may be further taken into consideration. For example, if the main driving region according to the driving history is a high current region or the driving mode is a sport mode, the rate of change of the reference cell voltage ratio may be determined to gradually decrease (L62). Also, if the main driving region according to the driving history is a low current region or the driving mode is an eco mode, the rate of change of the reference cell voltage ratio may be determined to gradually increase (L63). However, this is an example of a case where the protection of the stack 100 is a (e.g., higher) priority, and the opposite case may also be assumed when drivability is a (e.g., higher) priority.

Meanwhile, when the voltage of the stack 100 decreases and reaches a preset reference voltage, the controller 200 may determine whether the cell voltage ratio is less than the reference cell voltage ratio.

The cell voltage ratio generally corresponds to the performance of the stack 100, but the cell voltage ratio may temporarily decrease due to factors such as flooding and drying, and if the available lower limit voltage is adjusted in a temporary decrease state, the output of the stack 100 may be unnecessarily limited. Accordingly, the controller 200 may prevent unnecessary output limitation by not adjusting the available lower limit voltage in a case where the voltage of the stack 100 does not reach the reference voltage even if the cell voltage ratio becomes less than the reference cell voltage ratio.

In addition, when determining the timing of adjustment of the available lower limit voltage only based on the cell voltage ratio and reference cell voltage ratio, there may also be cases where the available lower limit voltage is adjusted after a sense of heterogeneity has already occurred due to a decrease in output. Whether or not the voltage of the stack 100 reaches the reference voltage may be used as a starting condition for determining performance degradation of the stack 100, so that adjustment of the available lower limit voltage may be performed at an appropriate time.

This reference voltage may be set based on the available lower limit voltage, and in this case, the offset voltage corresponding to the driving state of the vehicle may also be considered.

Here, the driving state may be determined based on, for example, the opening amount of the accelerator/brake pedal, the rotational speed and torque of the drive system, vehicle speed, acceleration, road conditions, and/or GPS coordinates. The offset voltage may have a larger value, for example, when the judged driving state corresponds to a high output state compared to when the judged driving state corresponds to a low output state. In other words, the offset voltage may serve as an element to increase the reference voltage in preparation for a high output situation.

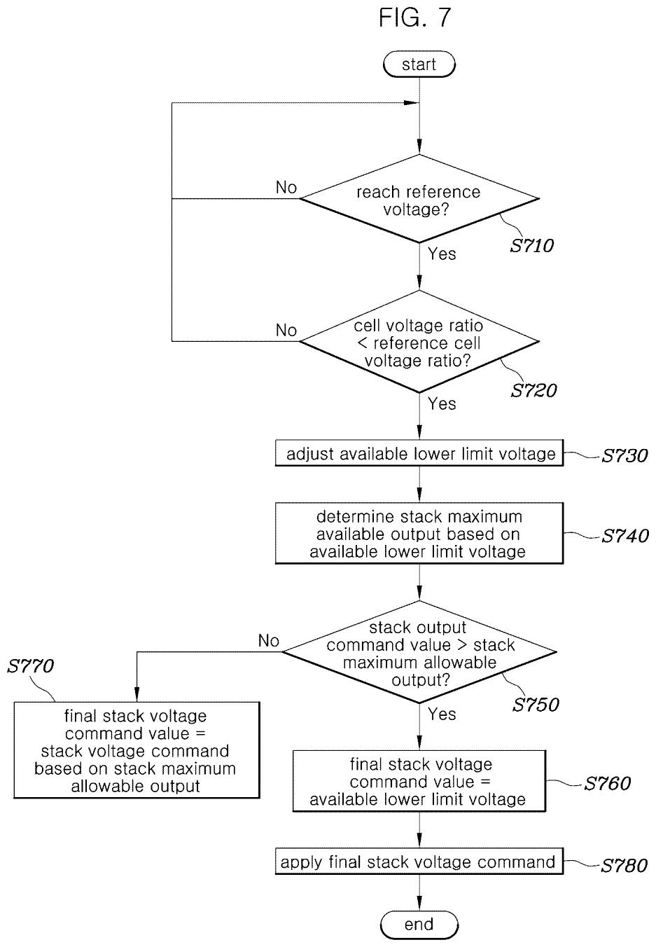

Hereinafter, a method of controlling a fuel cell system according to an embodiment of the present disclosure will be described with reference to FIG. 7.

FIG. 7 is a flowchart for explaining a control method of a fuel cell system according to an embodiment of the present disclosure.

Referring to FIG. 7, first, when the voltage of the stack 100 reaches a preset reference voltage during operation of the fuel cell stack (Yes in S710), the controller 200 compares the cell voltage ratio and the reference cell voltage ratio to determine whether to adjust the available lower limit voltage (S720).

As a result of the comparison, if the cell voltage ratio is less than the reference cell voltage ratio (Yes in S720), the controller 200 adjusts the available lower limit voltage based on the first margin and/or the second margin (S730), and determines the maximum allowable output of the stack 100 based on the adjusted available lower limit voltage (S740).

If the output command value of the stack 100 exceeds the maximum allowable output of the stack 100 (Yes in S750), the output of the stack 100 is limited, and the final stack voltage command value may be determined by the available lower limit voltage of the stack 100 (S760). Also, if the output command value of the stack 100 is less than or equal to the maximum allowable output of the stack 100 (No in S750), the output of the stack 100 is not limited according to the available lower limit voltage, and the final stack voltage command value may be determined by a stack voltage command based on the maximum allowable output of the stack 100 (S770).

Thereafter, the controller 200 controls the output of the stack 100 according to the final stack voltage command value (S780).

Meanwhile, FIG. 7 mainly shows components related to the description of an embodiment of the present disclosure, and the control method of a fuel cell system may be implemented including more or fewer steps than this. The information about the fuel cell system described with reference to FIGS. 1 to 6 may also be applied to a control method of another fuel cell system in one embodiment.

According to various embodiments of the present disclosure as described above, it is possible to detect performance degradation of individual cells in advance during the operation of the fuel cell stack, and delay performance degradation before the performance of the fuel cell stack deteriorates to a replacement requirement level.

In addition, by variably controlling the available lower limit voltage of the fuel cell stack during operation of the fuel cell stack, it is possible to delay performance degradation of the fuel cell stack and alleviate the sense of heterogeneity due to output fluctuations.

Although the present disclosure has been illustrated and described in relation to specific embodiments of the present disclosure as described above, it is apparent to those skilled in the art that the present disclosure can be variously improved and changed without departing from the technical spirit of the present disclosure provided by the following claims.

What is claimed is:

1. A fuel cell system, comprising:
a fuel cell stack including a plurality of cells; and
a controller configured to control an output of the stack based on an available lower limit voltage of the stack, and adjust the available lower limit voltage of the stack by reflecting at least one of a first margin according to a cell voltage ratio which is a ratio of a minimum cell voltage and an average cell voltage of the stack and a second margin according to an available output of a battery provided in the system when the cell voltage ratio is less than a preset reference cell voltage ratio.

2. The fuel cell system of claim 1, wherein the first margin has a different value for each of a plurality of cell voltage ratio sections of the stack, and has a higher value in a section where the cell voltage ratio is low compared to a section where the cell voltage ratio is high.

3. The fuel cell system of claim 2, wherein the first margin has a minimum value at a point where the cell voltage ratio is equal to the reference cell voltage ratio, and converges to a maximum value as the cell voltage ratio approaches ‘0’.

4. The fuel cell system of claim 3, wherein a starting point where the first margin converges to the maximum value is determined based on at least one of a pre-stored driving history and a preset driving mode.

5. The fuel cell system of claim 1, wherein the second margin has a different value for each of a plurality of sections for the available output of the battery, and has a lower value in a section where the available output of the battery is low compared to a section where the available output of the battery is high.

6. The fuel cell system of claim 5, wherein the second margin has a maximum value in a section where the available output of the battery exceeds a reference available output preset based on a maximum output of a drive motor provided in the system, and converges to a minimum value as the available output of the battery approaches ‘0’.

7. The fuel cell system of claim 6, wherein the maximum value and the minimum value are determined based on at least one of a pre-stored driving history and a preset driving mode.

8. The fuel cell system of claim 1, wherein the controller is configured to adjust the available lower limit voltage by reflecting the first margin and the second margin at a preset reflection ratio.

9. The fuel cell system of claim 8, wherein the reflection ratio is set to correspond to a requested output and at least one of a pre-stored driving history and a preset driving mode.

10. The fuel cell system of claim 1, wherein the controller is configured to adjust the available lower limit voltage by further considering a margin relaxation ratio that varies depending on a change in current corresponding to the available lower limit voltage.

11. The fuel cell system of claim 10, wherein the margin relaxation ratio decreases with an increase in the current corresponding to the available lower limit voltage.

12. The fuel cell system of claim 1, wherein the reference cell voltage ratio is set to vary depending on a state of health (SOH) of the stack.

13. The fuel cell system of claim 12, wherein the reference cell voltage ratio has a different value for each of a plurality of SOH sections of the stack, and has a higher value in a section with low SOH compared to a section with high SOH.

14. The fuel cell system of claim 13, wherein the reference cell voltage ratio has a minimum value when the SOH of the stack exceeds a preset value corresponding to an initial state of the stack, and has a maximum value when the SOH of the stack is less than a preset value corresponding to a final state of the stack.

15. The fuel cell system of claim 14, wherein the reference cell voltage ratio of a section where the SOH of the stack is between a preset value corresponding to the initial state of the stack and a preset value corresponding to the final state of the stack is varied between the minimum value and the maximum value.

16. The fuel cell system of claim 15, wherein in the section where the SOH of the stack is between the preset value corresponding to the initial state of the stack and the preset value corresponding to the final state of the stack, a rate of change of the reference cell voltage ratio according to the SOH of the stack is determined based on at least one of a pre-stored driving history and a preset driving mode.

17. The fuel cell system of claim 1, wherein the controller is configured to determine whether the cell voltage ratio is less than the reference cell voltage ratio when a voltage of the stack decreases and reaches a preset reference voltage.

18. The fuel cell system of claim 17, wherein the reference voltage is set based on the available lower limit voltage.

19. The fuel cell system of claim 18, wherein the reference voltage is set in further consideration of an offset voltage corresponding to a driving state of the system.

20. A control method of a fuel cell system, the method comprising:
comparing, by a controller, a cell voltage ratio, which is a ratio of a minimum cell voltage and an average cell voltage of a fuel cell stack including a plurality of cells, with a preset reference cell voltage ratio;
adjusting, by the controller, an available lower limit voltage of the stack by reflecting at least one of a first margin according to the cell voltage ratio and a second margin according to an available output of a battery provided in the system when the cell voltage ratio is less than the preset reference cell voltage ratio; and
controlling, by the controller, an output of the stack based on the available lower limit voltage.
